(19) United States
(12) Patent Application Publication
(10) Pub. No.: US 2003/0115106 A1
(43) Pub. Date: Jun. 19, 2003

(54) Method and apparatus configured to manage a procurement process

(76) Inventors: Jerry L. Crayton, Brimfield, IL (US); Steven J. Gibson, Mapleton, IL (US)

Correspondence Address: CATERPILLAR INC., 100 N.E. ADAMS STREET, PATENT DEPT., PEORIA, IL, 616296490

(21) Appl. No.: 10/020,147

(22) Filed: Dec. 14, 2001

(51) Int. Cl. G06F 17/60

(52) U.S. Cl. 705/26

(57) ABSTRACT

The present invention includes a method and apparatus configured to manage at least one aspect of a procurement process. The method includes the steps of establishing a value threshold, establishing a transaction, the transaction having an associated transaction value; comparing the transaction value of the transaction with the value threshold, and managing at least one aspect of the procurement process in response to the comparison.

### TECHNICAL FIELD

This invention relates generally to a method and apparatus configured to manage a procurement process, and more particularly, to a method and apparatus configured to manage one aspect of a procurement process.

### BACKGROUND

There are many guidelines that have been established to foster providing identified classes of supplier's opportunities to bid on transactions for goods and/or services. The guidelines may be established by a company for internal use, or use with other companies or groups they have dealings with. Or the guidelines may be established by governmental regulations. For example, there are many governmental regulations associated with ensuring that identified classes of suppliers, e.g., small business, small minority owned businesses etc., are provided an opportunity to bid on transactions. The guidelines and/or regulations often have certain procedures or processes that are required or suggested, related to soliciting identified classes of suppliers. For example, in one instance, if the value of a transaction is to exceed a particular value, the guidelines and/or regulations may recommend an aspect of the procurement process of the purchaser to be documented. Ensuring that the procurement processes of a company are compliant with established guidelines and/or regulations is a difficult and complex task.

The present invention is directed to overcoming one or more of the problems set forth above.

### SUMMARY OF THE INVENTION

In one aspect of the present invention, a method of managing at least one aspect of a procurement process is disclosed. The method includes the steps of, establishing a value threshold, establishing a transaction, the transaction having an associated value, and comparing the transaction value with the value threshold.

In another aspect of the present invention, an apparatus configured to manage a procurement process is disclosed. The apparatus includes a repository including at least one transaction, the transaction having an associated transaction value, and a monitoring system configured to establish a value threshold and compare said transaction value with said value threshold.

### BRIEF DESCRIPTION OF THE DRAWINGS

FIG. 1 illustrates one embodiment of a method associated with the present invention;

FIG. 2 illustrates one embodiment of an apparatus associated with the present invention;

FIG. 3 illustrates one embodiment of display screen that may be associated with the present invention; and

FIG. 4 illustrates another embodiment of a display screen that may be associated with the present invention.

### DETAILED DESCRIPTION

The present invention includes a method and apparatus configured to manage at least one aspect of a procurement process. In general, a procurement process may include a purchaser, or buyer, establishing a transaction that the purchaser desires to have filled. A transaction may be an agreement to purchase or lease goods and/or services. The transaction includes an associated transaction value, which will be described below. The transaction may be between one company and another, a company and a group or organization, between a company and a local, state, and/or federal government, or any combination thereof, or may involve and/or include any party desiring to enter into, or having entered into a transaction with another party. Establishing a transaction may include several stages of a transaction, such as an initial establishment phase before a request or solicitation for bids has been made (e.g., where the purchaser knows they would like to purchase or lease goods and/or services but have not solicited bids), a supplier selection process or phase (e.g., including where one or more suppliers are identified to solicit bids from, soliciting the bids, reaching an agreement with a supplier regarding the desired goods and/or services), an active period, where the transaction has been agreed to (i.e., an offer made and accepted by a supplier) and goods and/or services are being supplied by the supplier, and an inactive or completed period, where the transaction has been closed (e.g., the goods and/or services have been delivered and the transaction fulfilled, or the transaction has been terminated). A purchase order, which may be generally characterized as an offer to purchase and/or lease goods and/or services may be considered a form of transaction, which may be accepted by a supplier by signing the transaction, delivering the goods and/or services, or some other form indicating acceptance of the terms and conditions of the transaction. In addition, a contract may be characterized as a form of transaction.

In one embodiment, the transaction may indicate that the purchaser desires to buy one gasket at price X. In addition or alternatively, a transaction may indicate that the purchase desires to purchase up to one hundred gaskets at a price Y, which may be a reduced price due to volume. In some instances, a transaction may be for a fixed amount of money and/or a fixed amount of time. In other instances the amount of money and/or time may not be fixed. For example, a transaction may be for the purchase of any gaskets needed during the course of a time period (e.g., a year), at a price of Z per gasket. There may be times when it is uncertain exactly how many goods and/or services will be needed during the time period. However, the transaction may be drafted to accommodate these uncertainties.

As described above, the procurement process may include any and/or all phases of a transaction, from the initial establishment (e.g., identifying a desire to purchase or lease goods and/or services), through the supplier selection process, and/or the active period of the transaction, and/or through to the completion and/or termination of the transaction. When a purchaser does establish a good or service they desire to have supplied, they may perform a supplier selection process. The supplier selection process may include identifying one or more suppliers to solicit bids, soliciting bids from one or more suppliers and selecting a supplier to fulfill the transaction. In one embodiment, there may be supplier selection guidelines, or criteria, that provide guidelines on how to perform one or more characteristics of the procurement process, including the supplier selection process. The guidelines may include governmental guidelines, (including regulations) and/or internal guidelines associated with the procurement process. The guidelines may pertain when and how small businesses should be considered in the procurement process. For example, there may be a guideline that indicates that for any purchase or lease over a particular amount (or value), it is recommended that an identified class of suppliers be provided an opportunity to participate in the supplier selection process. In one example, the identified class of suppliers may include small, minority run businesses. The guidelines may also provide recommendations to document one or more characteristics of the procurement process so that the process can be reviewed later to determine whether the guidelines where adhered to. For example, the guidelines may indicate that for any transaction that exceeds, or will exceed, a value threshold, e.g., a specified dollar amount, then at least one aspect of the supplier selection process should be documented.

When one or more suppliers respond to the solicitation or request for bids, the purchaser may select one (or more) suppliers to fulfill the transaction. At that time the transaction may considered to be activated (become active) and sent to the supplier to begin work.

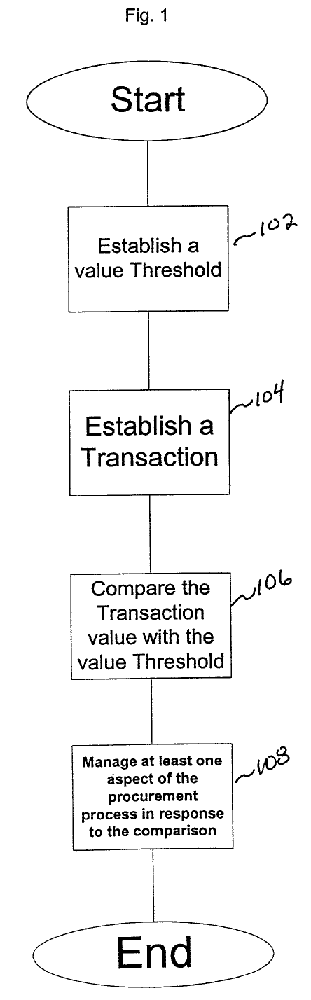

FIG. 1 illustrates one embodiment of a method of managing at least one aspect of a procurement process. The method may include the steps of establishing a value threshold, establishing a transaction, the transaction having an associated value, comparing the transaction value with the value threshold, and managing at least one aspect of the procurement process in response to the comparison.

In a first control block 102, a value threshold is established. In one embodiment, a value threshold may be an indicator that is used as a trigger to initiate an action associated with at least one aspect of the procurement process. In one embodiment, the value threshold may be a dollar amount associated with a transaction. For example, an administrator or user of the system may decide to establish the value threshold at $5,000. Alternatively the value threshold may be a dollar amount associated with a transaction during a specified time period, e.g., $5000 over the course of any one year period of the transaction. In one embodiment, the value threshold may be associated with more than one transaction. For example, the value threshold may be based on a percentage of all transactions, or a percentage of all transactions over a specified time period, or all active transactions. In one embodiment, the value threshold may be established in response to a procurement process guideline, or a supplier selection guideline (which may be included or separate from procurement process guidelines). As described above, these guidelines may be developed internal to the organization, or developed externally (e.g., by a governmental organization such as a local, state, or federal organization, body, or government). In addition, the guidelines may be provided from a one commercial organization to another. For example, a manufacturer may supply the guidelines to a supplier who will use the guidelines when they procure parts or services associated with the goods or services that they will provide to the manufacturer. In one embodiment, the guidelines may specify a value threshold, or a characteristic of a value threshold that may be used by to establish the value threshold. For example, the guidelines may indicate that an aspect of the procurement process should be managed in response to a transaction having a value that exceeds a value threshold, e.g., $5,000. For example, some aspect of the supplier selection process as it relates to an identified class of suppliers should be documented if a transaction has (or is predicted to have) a value that exceeds a value threshold.

In a second embodiment 104, a transaction is established. As mentioned, a transaction may include a desire, request, and/or agreement to purchase goods and/or services. The transaction includes an associated transaction value, which may include a desired, predicted, requested and/or agreed upon price or value for the good(s) and/or service(s). A transaction may include: a desired transaction, e.g., identified good(s) and/or service(s) that are desired to be purchased or leased but have not had associated bids solicited; a transaction being developed, e.g., some information associated with the goods and/or services are in a supplier selection process (e.g., potential suppliers are identified and/or supplier bids are being solicited, reviewed, and/or a supplier has been selected); an issued and/or active transaction (e.g., a transaction that is being fulfilled by a supplier); and a completed and/or inactive transaction such as one that has been fulfilled and/or one that has been terminated prior to fulfillment. Establishing a transaction may include identifying the desire for a good and/or service, and that the good and/or service may be provided by an external source, e.g., a supplier, or an internal source (e.g., group within the company or a subsidiary). In addition the transaction value associated with the transaction may be a predicted dollar amount that the goods and/or service is anticipated to cost. In the case of a transaction that has not been issued, e.g., the purchaser may know they want to purchase goods and/or services, but have not established a price or a supplier, the transaction value may be the predicted dollar amount established based on the predicted value of the goods or services, or similar goods or services, purchased or leased in the past, or a catalogue price, or estimates for the goods and/or services. Therefore, in one embodiment, the transaction may be based on an identified desire, and has not been submitted to any suppliers for bidding purposes.

In one embodiment, the establishment of a transaction value associated with a transaction may be based on responses to the solicitation of bids, and determined prior to the actual selection of a supplier. In addition, the transaction values may include catalogue prices. In an alternative embodiment, a request for bids may have been submitted to one or more suppliers, based on the identified goods and/or services desired. The responses to the bids may have been reviewed and a supplier selected. The transaction value may be a price of at least one of the goods and/or services associated with the transaction, a predicted value of the transaction, or an actual committed value of the transaction.

In one embodiment, the agreed upon price of a transaction, or portion thereof, may be a catalogue price. That is, if one or more suppliers has up to date catalogue information, the supplier selection process may include identifying a catalogue price for a designated good and/or service, and using the catalogue price as an offer to buy, lease, and/or sell. The catalogue may be a physical or electronic catalogue. In one embodiment, the transaction value associated with a transaction that has become active (or recently issued) includes the price for the established good(s) and/or service(s). For example, the price for 100 gaskets at $1.00 each, may be $100.00, i.e., the total price of the goods and/or services. Alternatively, the price may be for one or more of the goods and/or services to be purchased, e.g., $1.00 for the gasket.

In one embodiment, the transaction value may include an unspecified amount. For example, the transaction may be for all the gaskets that the buyer needs to purchase over a specified time period. The purchaser may know that they will pay $1.00 for each gasket, but may not know exactly how many gaskets they will need to purchase. In one embodiment, the transaction may have limits, e.g., $1.00/gasket for up to 100 gaskets. In this embodiment, the transaction value for the transaction may include the maximum quantity that the transaction allows for, e.g., $1.00 times 100 equals $100.00. Alternatively the purchaser may not be able to put a cap on quantity. In this embodiment, the transaction value may include the price for any one of the goods and/or services, or may be a predicted value. For example, the purchaser may be able to predict the amount to be purchased or leased during the transaction based on a projected need of the requester of the goods or services (i.e., the person or group who has requested the purchaser to acquire the goods and/or services from the supplier). A predicted value may be determined based on a predicted amount to be purchased/leased and a price associated with the goods and/or service.

In one embodiment, the transaction value may include the charges associated with the transaction up to a particular point in time. For example, some transactions may allow for an unspecified number of gaskets to be purchased over the course of a year, at $1.00 apiece. There may be 50 gaskets that have been purchased three months after the issuance of the transaction. In this context the amount purchased may include the amount requested, received, and/or invoiced. Therefore, if the purchaser has requested the delivery of 50 of the gaskets, and/or has received 50 gaskets, and/or has been invoiced (e.g., charged) for 50 gaskets, then the transaction value may include $50.00, the charges for the amount purchased against the transaction. These charges may be referred to as actual committed value. For example the actual committed value may be the value associated with the transaction that the purchaser/lessor has committed to, including actually paid for, requested, and/or been invoiced for. In one embodiment, the transaction value may be a predicted value based on the gaskets purchased to date. For example, if 50 gaskets are purchased in the first three months, then the predicted amount may be 200 for one year period.

In one embodiment, the transaction value associated with the transaction may include a predicted value. For example, if a transaction has not been issued, or the amount or cost is open in the transaction, then the transaction may be compared with one or more other transactions for the same or analogous goods or services. Based on this comparison a predicted value may be established. For example, if a transaction is issued for the purchase of gaskets over a specified time period @ $1.00/gasket, a comparison may be made with other transactions associated with gaskets to predict how many gaskets may be needed over the time period. As will be described below, a repository of information associated with transactions, which may include the transactions themselves, may be established. This repository may then either be manually reviewed, or reviewed in an automated fashion to determine if there are any transactions analogous to the one being addressed. For example, the review may indicate three other transactions previously issued for gaskets. The purchase quantity may have been for 50, 100, and 150 respectively, over a specified time period. Therefore, the predicted purchase quantity may be 100 (the average of the three over the specified time period), or 150, the maximum of the three over a specified time period, or some other predicted value based on the quantity previously purchased. In one embodiment, the predicted purchase amount may be for $150.00 (150 predicted gaskets @ $1.00 apiece).

In one embodiment, transactions associated with analogous goods and/or services may be used to determine a predicted value. For example, if the gasket is to be used in conjunction with a screw on a particular assembly, then a search on previous transactions for the screw may indicate that the previous screw quantities over a specified time period were 50, 100 and 150, for three identified purchases order respectively. From this a predicted quantity may be established, e.g., that 150 gaskets will be needed based on the maximum quantity of screws purchased. The predicted quantity may then be used to determine a predicted value (e.g. 150 gaskets @ $1.00 apiece equals $150.00 predicted value). Therefore, the transaction value may include a predicted value associated with a transaction.

In a third control block 106, the transaction value associated with the transaction may be compared with the value threshold. For example, the comparison may include comparing the price of one or more of the goods and/or services associated with the transaction, the actual committed value (e.g., charges associated with the amount requested, received, and/or invoiced of the transaction), and/or the predicted value of the transaction, with the value threshold.

In a fourth control block 108, at least one aspect of the procurement process may be managed in response to the comparison. In one aspect of the present invention, the procurement process includes performing a supplier selection process. The supplier selection process includes the process by which the purchaser determines which supplier they would like to have deliver the desired goods and/or services. As described above, once a transaction is identified that is desired to be fulfilled, then one or more potential suppliers may be identified, then the purchaser may send a request for bids out to one or more the identified suppliers. In addition, the purchaser may access a catalogue (physical or electronic) that indicates a supplier's prices. In one embodiment of the invention, management of one aspect of the procurement process may include documenting a characteristic of the procurement process, which may include the supplier selection process, in response to the transaction value, or a portion thereof, being greater than the value threshold. For example, the procurement process may include establishing a supplier selection guideline. As indicated above the guidelines may be internally established, or externally established, e.g., via a governmental regulation. The guidelines may specify that for any transaction having a value over a specified amount (the value threshold), certain procedures should be followed. For example, for any transaction value over a value threshold of $100,000, the supplier selection process, or an aspect thereof should be documented. If the comparison indicates that the price of one or more of the goods and/or services of the transaction, or the actual committed value, or the predicted value of the transaction, exceeds the value threshold, e.g., $100,000, then at least one aspect of the supplier selection process is to be documented. Therefore, in one embodiment, management of the procurement process in response to the comparison of the transaction value and the threshold value includes documenting one aspect of a supplier selection process if the transaction value exceeds the value threshold. The documentation that may be included is described below. In one embodiment of the present invention, the comparison may include determining if the transaction value is within a range of the value threshold. In this embodiment, if the transaction value is, or is predicted to be within a range (e.g., a dollar amount or percentage of) of the value threshold, then one aspect of the procurement process may be managed, e.g., one aspect of the supplier selection process may be documented.

In one embodiment, managing one aspect of the procurement process includes notifying the purchaser to document an aspect of the selection process in response to a determination that a transaction value of the transaction will (or does) exceed the value threshold. The documentation may be associated with an identified class of supplier, such as a small business, or small minority owned business. The documentation requested may include, a description of the material and/or services ordered, the suppliers quoted, and the suppliers selected. In addition, the documentation may include information regarding whether the selected supplier is a small business, small disadvantaged business, woman owned business, disabled veteran small owned business, veteran owned small business, and/or hub zoned business. In addition, the same type information may be documented regarding the suppliers from which bids were requested, or solicited. The documentation may also include the sources of solicitation. Sources of solicitation may include the sources used to identify the potential suppliers. For example, a source of solicitation may include SBA Pro-net, an internal SDB database, TRYFUS, or other source. The documentation may also include information regarding if no business associated with the identified review, e.g., no small business, was solicited, why were none solicited. In addition, if businesses within the identified class of business were solicited, e.g., small business, but not selected, why were they not selected. The documentation may also include any additional comments the purchaser has regarding the selection process or the supplier chosen.

Therefore, in one embodiment of the present invention a repository of information associated with the procurement process may be established. The repository may include the documentation associated with the procurement process, e.g., the documentation regarding the supplier selection process. Therefore the repository may be monitored to determine which transactions are going to exceed, have exceeded and/or are predicted to exceed the value threshold, e.g., will a transaction value of a transaction exceed the value threshold. For example when a transaction is being established, and the value of one or more goods and/or services, or predicted value, will exceed the value threshold, then a notification may be sent to the purchaser to document an aspect of the supplier selection process in the requested manner, i.e., provide documentation regarding at least one aspect of the selection process. Alternatively, a check may be initially made to determine if the documentation has been supplied, and if it has not, then the purchaser may be notified to enter the information. In addition, the actual committed value associated with the transaction, e.g., the amount requested, received, and/or invoiced associated with the transaction may be monitored to determine if the actual amount of the transaction has exceeded the value threshold. In this embodiment, the repository may be checked to determine if the designated documentation has been provided by the purchaser, and if it has not, then the purchaser may be notified if the value exceeds the value threshold (or comes within a range of the value threshold), to provide the designated documentation regarding the selection process. In one embodiment, the documentation provided by the supplier may be compared against the requested documentation. If there is any requested information missing, then the purchaser may be notified to enter the missing information.

In one embodiment, management of the procurement process may include taking an action in response to the comparison between the value threshold and the transaction value. In one embodiment, the action may be associated with documenting an aspect of the procurement process, as discussed above. In one embodiment, if the transaction value, e.g., price, and/or predicted value, associated with a transaction was not expected to exceed the value threshold (or come within a designated range of the value threshold), then an aspect of the supplier selection process may not have been documented, or may not have included a solicitation from an identified class of suppliers, e.g., small businesses. Then when the transaction value changes, e.g., actual committed value associated with a transaction, exceeds the value threshold, the transaction may be re-bid to include solicitations to the identified class of suppliers. Alternatively, when the transaction has expired, but is desired to be renewed, the transaction may be re-bid to include solicitations to the identified class of suppliers. In one embodiment, when the transaction value, e.g., actual committed value associated with a transaction, exceeds the value threshold, then the purchaser may be notified to re-bid the transaction, or to expand the suppliers solicited if the transaction, or parts and/or services associated with the transaction or re-bid. In one embodiment, the decision to re-bid the transaction to include the identified class of suppliers, or to expand the suppliers solicited if the transaction is re-bid or renewed, may be documented in a repository, such as the repository having the information associated with the procurement process. In addition, the method illustrated in FIG. 1 may be performed manually, implemented in a computer system, or some combination thereof.

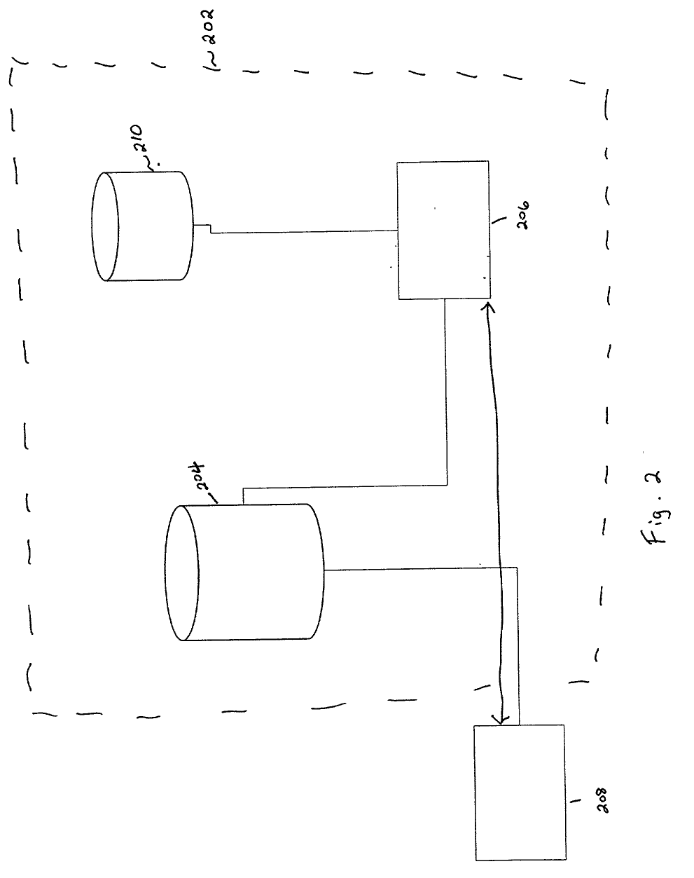

FIG. 2 illustrates one embodiment of an apparatus 202 configured to manage a procurement process. In one embodiment, the apparatus includes a repository 204 of information, including information associated with the procurement process. The information may include information associated with at least one transaction, including the associated transaction value. The apparatus may also include a monitoring system 206 configured to establish a value threshold, compare the value threshold with the transaction value, and manage at least one aspect, or characteristic of the procurement process in response to the comparison. In one embodiment, a user may input a value threshold into the monitoring system 208. The value threshold may be used as a trigger by the monitoring system 206 in order to manage at least one aspect of the procurement process. For example, if the value threshold is less than a transaction value associated with a transaction, then an action may be initiated, thereby managing at least one aspect of the procurement process. The value threshold may be established dynamically based on an internal guideline, or an external guideline, e.g., a governmental guideline and/or regulation. In an alternative embodiment, the value threshold may be stored in the repository, or locally within the monitoring system based on the internal or external guidelines, and recalled by the monitoring system when appropriate. In one embodiment, the monitoring system 206 may have access to an electronic source of the value threshold, and may access that source to obtain the threshold. For example, if the value threshold is established based upon a governmental guideline, the monitoring system may be able to access a computer system maintained by the government and including the value threshold. The monitoring system may be able to obtain the value threshold from the computer system, thereby establishing the value threshold based upon the most recent information.

In one embodiment of the present invention, the monitoring system 206 may access the transaction value associated with a transaction, located in the repository 204. The monitoring system 206 may access all, or a portion, of the transaction values, on an established basis. For example, on a daily, or some other basis, the monitoring system 206 may automatically execute a batch job that accesses one or more of the transaction values of one or more transactions in the repository 204. The monitoring system 206 may maintain, or access a list of each transaction, or a portion thereof, or associated information, and the associated transaction value. The monitoring system 206 may then compare the transaction value with the value threshold. The monitoring system 206 may then manage one aspect of the procurement process in response to the comparison. For example, in one embodiment, the monitoring system 206 will compare the transaction value to the value threshold. If the transaction value exceeds the value threshold, then the monitoring system may check the repository to determine if desired documentation associated with a procurement process, such as the supplier selection process has been entered. Alternatively, if the transaction value is within a range (e.g., a dollar or percentage range), then the monitoring system may check the repository to determine if desired documentation associated with a procurement process, such as the supplier selection process has been entered. In one embodiment, the monitoring system may access the repository and access information associated with a particular transaction. The information being accessed may be data associated with the supplier selection process. The information may be associated with small business, or small minority owned business. For example, the documentation may include, a description of the material and/or services ordered, the suppliers quoted, and the suppliers selected. In addition, the documentation may include information regarding whether the selected supplier is a small business, small disadvantaged business, woman owned business, disabled veteran small owned business, veteran owned small business, and/or hub zoned business. In addition, the same type information may be documented regarding the suppliers from which bids were requested, or solicited. The documentation may also include the sources of solicitation. For example, where the sources SBA Pro-net, an internal SDB database, TRYFUS, or other source. The documentation may also include information regarding if no business associated with the identified review, e.g., no small business, was solicited, why were none solicited. In addition, if businesses within the identified class of business were solicited, e.g., small business, but not selected, why were they not selected. The documentation may also include any additional comments the purchaser has regarding the selection process or the supplier chosen.

If the information is not available for a particular transaction, and the transaction value exceeds the value threshold, the monitoring system may notify the purchaser responsible for the particular transaction and request that the purchaser enter the desired information. The notification may occur via an automated e-mail that may be generated when the transaction value exceeds the value threshold, and the information has not been entered. Alternatively, the notification may occur by an automated fax being generated, or some other electronic notification form, include telephone notification. The purchaser may be receiving the notification on computer workstation 208, e.g., via e-mail. The computer workstation 208 may be part of the apparatus 202, or may be separate from, but electronically connected to the apparatus 202. In addition, the purchaser may access the repository 204 to store the appropriate information associated with a transaction. For example, the purchaser may access the repository from a computer workstation 208, as illustrated in FIG. 2. In one embodiment, the user may access the repository directly, or access the repository via the monitoring system.

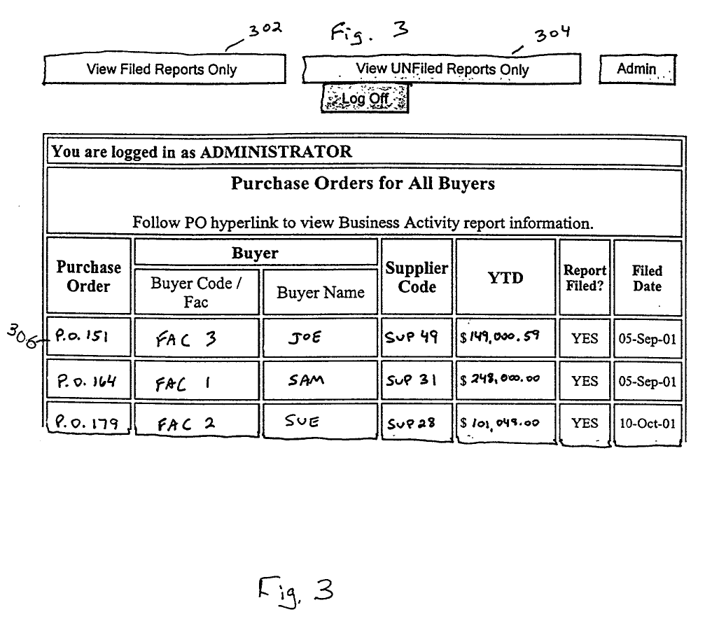

In one embodiment, the monitoring system may access, or maintain a list of information associated with the process, e.g., information associated with the transactions. FIG. 3 illustrates one embodiment of a list of transactions that is accessed or maintained. The information may include buyer code, buyer name, supplier code, a transaction value associated with the transaction, e.g., a year to data purchase amount associated with the transaction, an indication of whether the designated documentation associated with a report has been filed, and if so, on what date. The list may be interactive. For example, someone viewing the list on a screen may have the ability to view all the transactions in which the designated information has been entered (e.g., via activating button 302), all the transactions in which the designated information has not been entered (e.g., via activating button 304), or both (via activating a button not shown). In addition, someone may view all the transaction associated with the apparatus where a transaction value exceeds the value threshold.

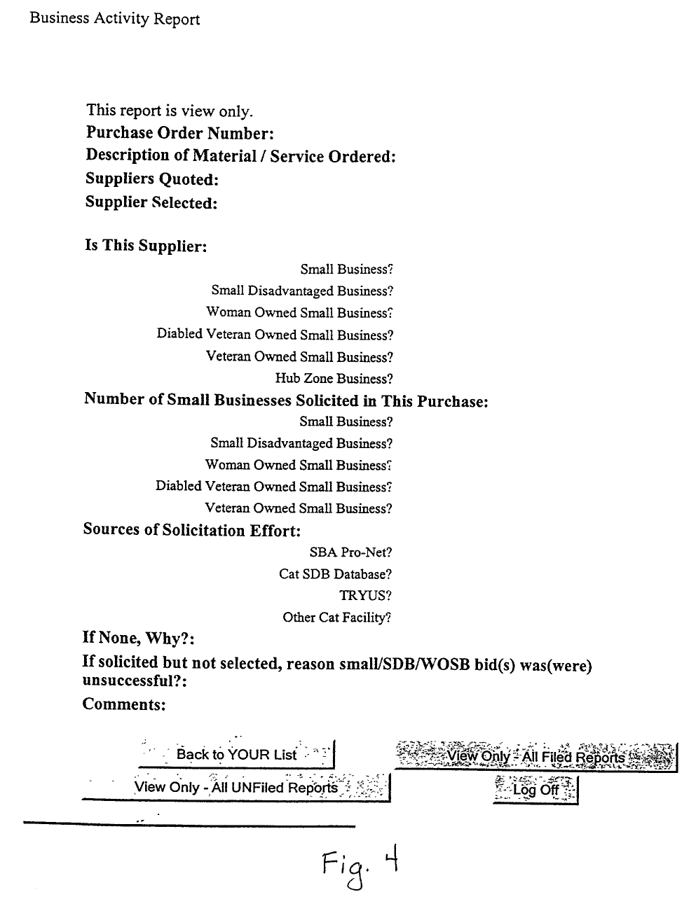

In one embodiment, the list may include an identifier 306 of the transaction. The identifier may be illustrated as a hyperlink, which when activated, may access and display additional information associated with the transaction. For example, in one embodiment the information designated to be documented may be displayed, as illustrated in FIG. 4.

In one embodiment, the monitoring system 206 may be accessed via the internet, or an intranet (a local network enabling users of the network to access websites available to the local network). Therefore, in one embodiment, a user of the monitoring system 206 may be provided a password and user name. The user may access the web site having access to the monitoring system 206. In one embodiment, when the user logs on to the monitoring system they may have access to all of the options provided by the monitoring system, or a portion thereof, based upon their access rights. For example, a system administrator may have access to all of the information associated with the apparatus 202. Alternatively, a purchaser may have access only to the transactions they are responsible for. Therefore, a system administrator may log on and view all of the transactions, while a purchaser may log on and only have access to the transactions they are working on.

In one embodiment, a purchaser may be able to access the apparatus 202 and enter the desired information associated with the transaction, into the repository, as illustrated in FIG. 2. In an alternative embodiment, the purchaser may access the web site hosting the monitoring system 206, and then access the desired repository, via the monitoring system 206.

In one embodiment, when the transaction value exceeds the value threshold, a notification may be automatically sent to the purchaser to enter the information.

In one embodiment, the monitoring system 206 may access a repository of information associated with invoices. The invoice repository 210 may be included in the apparatus, or separate to it. In addition, the invoice repository may be included in the repository 204. The information associated with the invoices may be used to establish a transaction value associated with a transaction. In one embodiment, the monitoring system may access the repository of invoices associated with the transactions to establish a transaction value associated with a transaction that may be then compared to the value threshold, as described above.

In one embodiment of the present invention, an analysis system (not shown) may be included in the apparatus, or a separate process separate from the apparatus. In one embodiment the analysis system may be a subset of the monitoring system. The analysis system may review completed transactions to correlate transaction values that may be used for to predict future cost associated with a transaction. For example, a user may input to the analysis system, a product that the user would like historical information on. The information may be associated with the projected number of gaskets that will be used in a year. Therefore, the analysis system may search the repository of completed transactions to determine which ones apply to gaskets. The numbers be averaged, and/or a maximum number of gaskets purchased over a particular time period may be determined. In this manner, a predicted number of gaskets that will be used in a year may be determined. The predicted number of gaskets used may then be used to predict the value of the transaction. In addition, the average amount paid for each gasket and the maximum amount paid for each gasket may be determined. A predicted value for the gaskets may be determined by multiplying the predicted number of gaskets to be used over the time period, by the cost of each gasket. Gasket cost may be determined either based upon supplier quotations in response to the solicitations, or based on the average or maximum cost associated with prior purchases of gaskets. The analysis system is able to establish a predicted value associated with a transaction that either has not issued yet, or that is open ended. The predicted cost may then be used to predict if a particular transaction is going to exceed a value threshold, and thereby notifying the purchaser accordingly. In one embodiment, the monitoring system may perform a search on analogous or related parts to determine a predicted number of gaskets that will be used. The predicted number may then be used to predict the value of the transaction.

### INDUSTRIAL APPLICABILITY

The present invention includes a method and apparatus configured to manage at least one aspect of a procurement process. The method includes the steps of establishing a value threshold, establishing a transaction, the transaction having an associated transaction value, comparing the transaction value of the transaction with the value threshold, and managing at least one aspect of the procurement process in response to the comparison. In one embodiment, the value threshold is established in response to a federal guidelines. For example, the guidelines may indicate that for any transaction over $100,000, at least one aspect of the procurement process should be documented, such as one aspect of the supplier selection process. The number and type of an identified class of suppliers that were included in the solicitation of bids associated with the transaction, and associated reasons why they were or were not selected to fulfill the transaction may be documented in response to the transaction value of the transaction exceeding $100,000. Therefore, transaction values of transactions that are being created, or that are active, may be compared with the threshold to determine if they exceed the threshold, and if so the appropriate information may be documented.

In one embodiment, an apparatus may be used to manage one aspect of the procurement process. The apparatus may include a repository including information associated with at least one transaction, and a monitoring system configured to establish a value threshold, compare the value threshold with a transaction value of the transaction, and manage at least one aspect of the procurement process in response to the comparison. In one aspect of the present invention, a user may access the monitoring system, and view all the active transactions that have exceeded the value threshold, or a portion thereof. In addition the monitoring system may display whether the appropriate documentation has been submitted to the apparatus. The user may access additional information regarding the transaction by activating a hyperlink to view the information. The additional information may include the information documented regarding the supplier selection process. In one embodiment the monitoring system sends a notification when a transaction value does exceed the value threshold so that the purchaser may enter the designated information, if they have not already.

Other aspects, objects, and advantages of the present invention can be obtained from a study of the drawings, the disclosure, and the claims.

What is claimed is:

1. A method of managing at least one aspect of a procurement process, comprising the steps of:
establishing a value threshold;
establishing a transaction, said transaction having an associated value;
comparing said transaction value with said value threshold; and
managing at least one aspect of the procurement process in response to said comparison.

2. A method, as set forth in claim 1, wherein the step of managing said procurement process further includes the steps of performing a supplier selection process.

3. A method, as set forth in claim 2, wherein said transaction value includes a price associated with at least one of a good and a service associated with said transaction.

4. A method, as set forth in claim 3, wherein the step of managing said procurement process further includes the step of documenting a characteristic of said supplier selection process in response to said purchase price being greater than said value threshold.

5. A method, as set forth in claim 4, wherein the step of documenting said supplier selection process further includes the step of notifying a purchaser to document said supplier selection process characteristic.

6. A method, as set forth in claim 5, further comprising the step of selecting a supplier to fulfill said transaction in response to said supplier selection process.

7. A method, as set forth in claim 6, wherein the step of managing said procurement process further includes the steps of:
establishing a supplier selection guideline;
comparing said documentation with said selection guideline.

8. A method, as set forth in claim 7, wherein said transaction value includes an actual committed value of said transaction.

9. A method, as set forth in claim 8, further including the step of monitoring said actual committed value during an active period of said transaction.

10. A method, as set forth in claim 8, wherein the step of documenting said characteristic of said supplier selection process further includes the step of documenting said characteristic of said supplier selection process in response to said actual amount billed against said transaction being greater than said value threshold.

11. A method, as set forth in claim 2, wherein said transaction value includes a predicted transaction value.

12. A method, as set forth in claim 11, further including the steps of:
comparing a characteristic of said transaction with a characteristic of at least one previous transaction; and
determining said predicted transaction value in response to said comparison.

13. A method, as set forth in claim 12, wherein the step of managing said procurement process further includes the step of documenting a characteristic of said supplier selection process in response to said predicted billed amount being greater than said value threshold.

14. A method, as set forth in claim 13, wherein the step of documenting said supplier selection process further includes the step of notifying a purchaser to document said supplier selection process characteristic.

15. A method, as set forth in claim 14, further comprising the step of selecting a supplier to fulfill said transaction in response to said supplier selection process.

16. A method, as set forth in claim 15, wherein the step of managing said procurement process further includes the steps of:
establishing a supplier selection guideline;
comparing said documentation with said selection guideline.

17. A method, as set forth in claim 16, wherein the step of establishing said purchasing threshold further includes the step of establishing said purchasing threshold in response to said supplier selection guideline.

18. A method of managing a procurement process, comprising the steps of:
establishing a value threshold;
establishing a transaction, said transaction having an associated value;
comparing said transaction value with said value threshold;
performing a supplier selection process associated with said transaction, with at least one supplier;
documenting at least one characteristic of said supplier selection process in response to said comparison.

19. A method, as set forth in claim 18, wherein said transaction value includes a price associated with at least one of a good and a service associated with said transaction.

20. A method, as set forth in claim 19, wherein the step of documenting said supplier selection process characteristic further includes the step of documenting said supplier selection process characteristic in response to said purchase amount being greater than said value threshold.

21. A method, as set forth in claim 18, wherein said transaction value is an actual committed value of said transaction.

22. A method, as set forth in claim 21, wherein the step of documenting said supplier selection process characteristic further includes the step of documenting said supplier selection process characteristic in response to said actual amount billed against said transaction being greater than said value threshold.

23. A method, as set forth in claim 21, further including the step of monitoring said actual committed value during an active period of said transaction.

24. A method, as set forth in claim 18, wherein said transaction value includes a predicted transaction value.

25. A method, as set forth in claim 24, wherein the step of documenting said supplier selection process characteristic further includes the step of documenting said supplier selection process characteristic in response to said predicted billed amount against said transaction being greater than said value threshold.

26. A method, as set forth in claim 25, further including the steps of:
comparing a characteristic of said transaction with a characteristic of at least one previous transaction; and
determining said predicted billed amount against said transaction in response to said comparison.

27. An apparatus configured to manage a procurement process, comprising:
a repository including at least one transaction, said transaction having an associated transaction value;
a monitoring system configured to establish a value threshold, compare said transaction value with said value threshold, and managing said procurement process in response to said comparison.

28. An apparatus, as set forth in claim 27, wherein said transaction value includes a price of at least one of a good and a service associated with said transaction.

29. An apparatus, as set forth in claim 28, wherein said monitoring system is further configured to notify a purchaser associated with said transaction in response to said price being greater than said value threshold.

30. An apparatus, as set forth in claim 28, wherein said monitoring system is further configured to determine whether a documentation procurement process characteristic associated with said transaction has been documented in response to said price being greater than said value threshold.

31. An apparatus, as set forth in claim 30, wherein said monitoring system is configured to notify a purchaser associated with said transaction to enter said documentation procurement process characteristic.
